(19) United States
(12) Patent Application Publication
(10) Pub. No.: US 2017/0185998 A1
(43) Pub. Date: Jun. 29, 2017

(54) METHOD AND DEVICE FOR PROTECTING ACCESS TO WALLETS IN WHICH CRYPTO CURRENCIES ARE STORED

(71) Applicant: draglet GmbH, Munchen (DE)

(72) Inventor: Ganesh Jung, Muenchen (DE)

(21) Appl. No.: 15/325,125

(22) PCT Filed: Jun. 15, 2015
(86) PCT No.: PCT/EP2015/063279

§ 371 Date: Jan. 10, 2017

(30) Foreign Application Priority Data
Jul. 17, 2014 (EP) 14177520.5

(51) Int. Cl. G06Q 20/36; G06Q 20/38

(52) U.S. Cl. CPC G06Q 20/3674; G06Q 20/3678; G06Q 20/3829

(57) ABSTRACT

A method is provided for securing access to wallets in which crypto currencies and/or their secrets are stored. The method uses a transaction server on which transaction logic runs to perform a transaction with a client device controlled by a user. A user password and a unique ID are assigned to each user with a wallet server on which the wallets are managed, For the termination of a transaction, the access from the transaction server to the wallet server is based on the user password, an asymmetric server key pair, and a symmetric user key per user.

### BACKGROUND

1. Field of the Invention

The invention relates to a method and a device for securing access to wallets in which crypto currencies and/or their keys are stored, with a transaction server running a transaction logic for performing a transaction together with a client device controlled by a user.

2. Description of the Related Art

Crypto currencies such as Bitcoins are kept in so-called wallets. Crypto currencies are privately created money or fiat money in the form of digital means of payment. They use principles of cryptography to implement a distributed, decentralized and secure system of a digital complementary currency. In this context, reference is also made to Wiki https://en.wikipedia.org/wiki/Cryptocurrency.

In a crypto currency all participants communicate with each other via a peer-to-peer network. Each message that a subscriber sends to this network is available for each other subscriber. However, it will not be sent as a broadcast, but, as usual in P2P (pair to pair) networks, passed gradually from one participant to another. A message that is sent in this network thus corresponds to a publication to all participants.

First, each new subscriber creates a key pair for an asymmetric crypto system. The public key is published via the P2P network and, if applicable, elsewhere. The private secret key now allows the participants to sign orders for transactions cryptographically. Each user can open an account in this way. The account has a credit balance of zero as a newly created account. The published key is practically the account number and is called an account address. The private key secures the authority/control over the account. Since each participant can in principle generate as many as key pairs as he wants, the key pairs are kept in a file called a wallet. In this wallet the crypto currencies will also be stored, which is hereinafter referred as Bitcoin, this should not be intended to limit the scope of protection, but is intended to be a synonym for all crypto currencies.

Web wallets are protected by cryptographic keys and passwords. In order to automate disbursement requests from customers, these passwords and keys must be stored on a machine which, if required, performs payments on customer request.

Thus, wallets may reside on a variety of servers whose security standards may be of different quality.

Web sites that provide Bitcoin based services also use such wallets. Hackers, who are able to penetrate the servers of these websites, can exploit the bitcoins that are managed in these web wallets.

### SUMMARY

To secure such Web wallets against attacks the method and the system defined in the claims have been developed.

This system is based on a “crypto method”. The method stipulates that the storage of Bitcoins takes place on a separate wallet server. The communication between the Web server and the wallet server is protected by a cryptographic method based on the password of the customer, a common asymmetric key and a symmetric key per customer.

With the help of this method it will be prevented that attackers who manage to penetrate the transaction server, gain access to the customer deposits on the wallet server simultaneously. Since only the transaction server on the Internet is visible, a substantially increased security is achieved for the Wallets.

Two servers are used to secure the processing of wallet transactions Operated. On the transaction server runs the transaction logic of the service to be secured and on the wallet server the wallets are handled, from which transactions with cryptographic currencies can be started. Each customer has a password that is only known to him and an ID that clearly identifies him throughout the whole system.

In detail, the invention is a method for securing access to wallets in which crypto currencies and/or their keys are stored, with a transaction server on which a transaction logic is running for executing a digital transaction together with a client device controlled by a user, wherein each user has a user password and a unique ID assigned. Another component is a wallet server on which the wallets are managed. To terminate a transaction an access from the transaction server to the wallet server on the basis of the user password, an asymmetric server key-pair and a symmetric user key per user is done.

Herein preferably the symmetric user key is encrypted using the user's password and is stored encrypted on the transaction server, so that only the user has access to the user's key when entering the password. In one possible embodiment, there may be a log-in area for a user which can be used by the user to login in his personal account on the transaction server. In addition to these login information it might be necessary in another possible embodiment to enter the same or an additional password to decrypt the symmetric users key. The encryption method and the password should correspond to standards that allow an as strong as possible encryption.

Subsequently, the private key of the asymmetric server key pair which is stored in the wallet server and the public key of the asymmetric server key pair that is stored on the transaction server, is used to transmit the symmetric user keys.

For the exchange of the symmetric user key, the symmetric user key is transmitted from the transaction server encrypted by the public key of the asymmetric key pair to the wallet server and is there stored in relation to the user, in particular to the ID. The key is placed on a secure area on the wallet server. This secure area can be secured by a corresponding server key, which performs a corresponding encryption of all symmetric user keys, so that an unauthorized access is made more difficult.

It has to be ensured that each user has only one unique ID with a single symmetric user key. An Overwriting of this symmetric user key is prevented. Rather, a new record is created when a user key has to be deleted or changed. However, for this transaction special interventions into the system are necessary so that they are very difficult to be performed. Also, the symmetric user key is preferably only stored once, and is not permanently stored again. Thus the symmetric key is never overwritten on the wallet server, but only one symmetric key is written, when a user ID not yet exists.

In case there is a transaction in which a crypto-currency is required, then a transaction request is generated from the transaction server with respect to the user logged in accordance to the user ID.

In case of a transaction requests for disbursement of crypto-currency by the transaction server the symmetric key is decrypted by entering the user password, the transaction request together with the symmetric key is transmitted encrypted to the wallet server, and the payment is performed by the transaction server.

Since the symmetric key is preferably stored together with the unique user ID, on both the transaction server and on the wallet server, and since the user ID is also transmitted, an access can simply be performed.

In the event of a change of the user password the symmetrical user key is decrypted using the old password and encrypted with the new user password. The new symmetric user key is then transmitted according to the known method, the old key is deactivated and the new key is stored in a new memory area.

In order to establish a secure communication between the wallet server and the transaction server, the wallet server only allows authorized and/or authenticated transaction server to establish a communication. It should be noted that the communication is additionally protected and encrypted by certificates. Also, the access to a single server can for example be established via SSL or similar protocols that allow on the one hand the identification of the server or its address and on the other hand an encrypted data exchange. Moreover, additional login information from the transaction server may be required, so that the transaction server can log into the wallet server and can exchange data.

Another security approach is that the transaction server has only read access to the account balances of the wallet server and a transaction is only executed if the amount of crypto currencies is high enough. Here, corresponding requests from the transaction server are sent to the wallet server and the wallet server confirms, whether the corresponding amount of crypto currency is available. If necessary, a certain quantity of the crypto currency can be blocked so that the transaction can also be carried out.

In an other embodiment, a block chain method is used in order to determine the amount of the crypto currency.

In the block chain method there is a complete recording of transactions in a sequence of records, the so-called blocks. All computers on the network have a copy of the block chain which they keep up to date by interchanging new blocks. Each block contains a group of transactions since the previous block has been sent. To maintain the integrity of the block chain, each block in the chain confirms the integrity of the previous block, back up to the first block. The insertion of a block is difficult, since each block must meet certain requirements, making it difficult to generate a valid block. In this way, no party can override existing blocks.

Another component of the invention is a system for protecting accesses to wallets in which crypto currencies and/or their keys are stored, with a transaction server and a wallet server, characterized by a device and configuration that implements the method described above. This may be a standard server with a processor, memory, hard drives and network connections on which an operating system runs, that satisfies the appropriate requirements. Furthermore, on this operating system a corresponding software running that implements the functionality of the wallet server and transaction server. The connection of the system is via networks. This can either be a dedicated network between the two systems or a virtual private network (VPN), which is switched over the Internet.

### BRIEF DESCRIPTION OF THE DRAWINGS

FIGS. 1-3 show flowcharts of the invention.

### DETAILED DESCRIPTION

In the following, the invention is described with reference to specific command lines, which are also reflected in the corresponding figures.

The cryptographic processes are represented by means of openssl calls.

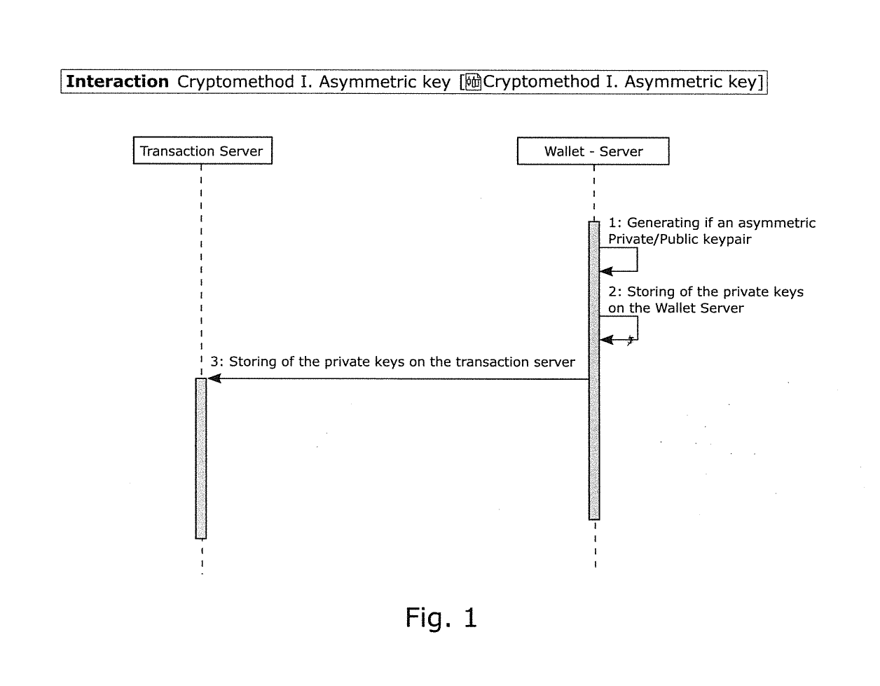

### I. Asymmetric key (FIG. 1)

1: Generation of an asymmetric private/public keypair
A standard RSA key with 4096 bit is used.
Openssl genrsa -out cryptoprocess.key 4096
Openssl rsa -in cryptoprocess.key -putout -out cryptoprocess.crt
2: Storage of the private key on the wallet server

The private key “cryptoprocess.key” is stored on the wallet server, the key “belongs” to the wallet server.

3: Storage of the public key on the transaction server

The public key “cryptoprocess.crt” is stored on the transaction server, the transaction server can now send secure messages to the wallet server.

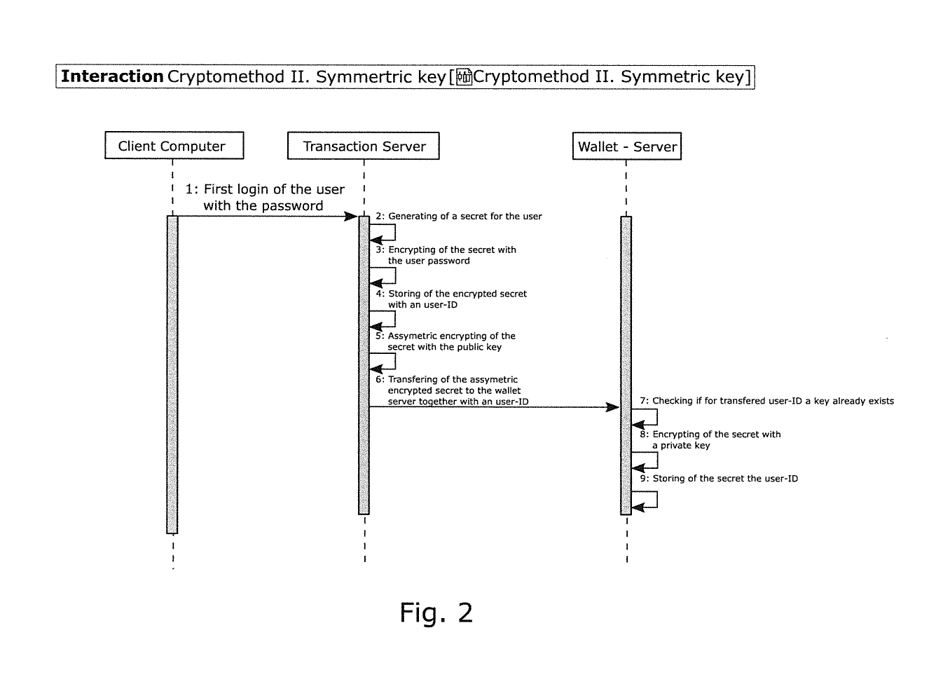

### II. Symmetrical key (FIG. 2)

For the symmetrical encryption of payment requests a secret for each customer on the transaction server is created. For the generation, a software should be used which can generate strong random values.
1: First login of the user with the user password
The secret is generated at the first login of the customer.
2: Creation of a secret for the user
For purposes of illustration, the secret is stored here in a file “secret.txt” of the transaction server. In the real implementation, the secret is only temporarily stored in the main memory of the generating process and the file is not permanently stored:
Openssl rand -base64 370|tr -d “\\n”> secret.txt

The length of the secret must be chosen in such a way that encryption is possible with the aid of the previously generated asymmetric key pair.

3: Encrypting the secret with the user password
The secret is encrypted with the customer's password (variable $kundenpasswort).
Cat secret.txt|Openssl aes-256-cbc -a -salt -pass pass: $kundenpasswort> password_encrypted_secret.txt
4: Storing the encrypted secret under the user ID
The encrypted secret is stored under the ID of the customer on the transaction server. On the transaction server, the secret is thus stored exclusively encrypted and can only be read if the customer's password is known.
5: Asymmetric encrypting of the secret with the public key

To transfer to the Wallet server, the secret is encrypted with the in section “I. Asymmetric Key” generated public key on the transaction server.

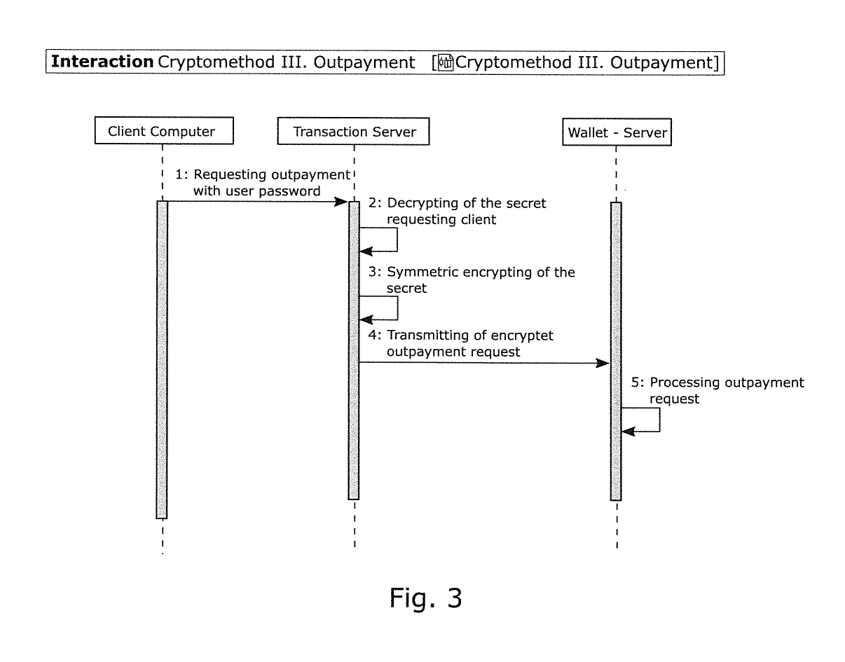

Cat ..\secret.txt|Openssl rsautl -encrypt -pubin -inkey cryptoprocess.crt |Base64> ../publickey_encrypted_secret.txt
6: Transferring of the asymmetrically encrypted secret to the wallet server along with the user ID
The asymmetrically encrypted secret is sent to the wallet server together with the ID of the customer. Since the message is encrypted, a message queue, a synchronized database table, or http, ftp or scp can be used as transport path.
7: Checking whether a key already exists for the transmitted user ID
The wallet server receives the encrypted message along with the customer's ID and checks if there is already a secret for that ID.
8: Decrypting of the secret using the private key
If no secret is available for this ID, the secret is decrypted using the private key.
Publickey_encrypted_secret.txt|Base64 -d|Openssl rsaut1-decrypt -inkey cryptoprocess.key> secret.txt
9: Storing of the secret under the user ID
The secret is stored under the ID of the customer.
III. Out payments (FIG. 3)
1: Payment request with user password
The customer must enter his/her password together with each payment request.
2: Decrypting of the secret of the requesting customer
The customer's password is used to decrypt the secret generated for the user.
3: Symmetric encrypting of the payment request
The payout request is encrypted symmetrically using the decrypted secret.
Echo “I am a payment request” openssl aes-256-cbc -a -salt -pass pass: ‘cat password_encrypted_secret.txt|openssl aes-256-cbc -d -a -pass pass: $kundenpasswort’> encrypted_message.txt
4: Send the encrypted payment request
The encrypted payment request is sent via a message queue, a synchronized database table, or via http, ftp or scp.
5: Process payment request

The payment request received on the wallet server is decrypted using the customer's secret stored on the wallet server under the ID of the customer cat encrypted_message.txt|openssl aes-256-cbc -a -d -pass pass: ‘cat secret.txt’

IV. Password management (without Fig.)
1: Password change
If the secret on the transaction server is encrypted with the customer password, it has to be decrypted with the old password (variable $ kundenpasswort_alt) in the case of the password change and encrypted with the new password (variable $kundenpasswort_neu).
cat password_encrypted_secret.txt|Openssl aes-256-cbc -d -a-pass pass: $kundenpasswort_alt|Openssl aes-256-cbc -a -salt -pass pass: $kundenpasswort_neu > password_encrypted_secret.txt

### 2: Password Recovery

In case of a password loss, the customer must be able to restore his password. However, this cannot happen automatically from the transaction server because an attacker who has control over the transaction server is just not allowed to gain access to the customer deposits on the wallet server. Without knowledge of the customer password, it may not be possible to obtain or change the secret generated for that customer.

For this reason, a method for password recovery that is not initiated by the transaction server should be established. One way to achieve this is a support request, which is processed in the back office. A support worker processes the support request, deletes the customer's secret from both the transaction server and the wallet server, and causes a password recovery mail to be sent to the customer. If the customer has chosen his new password, a new secret is created and the method from step “d) secret generation” is processed.

The attack possibilities are based on the assumption that the attacker has already get control of the transaction server and is now trying to access the customer deposits on the wallet server. If the attacker has created the user himself, he knows the password and can decrypt the secret. He can now send payment instructions at any height to the Wallet server.

As countermeasures, customers' account balances are managed on the wallet server based on the blockchain. The transaction server is allowed to access the accounts read-only. The Wallet server checks before each payout whether the client's credit is sufficient for the out payment.

In another form, the attacker might try to send a new secret to the wallet server. As a countermeasure, it can be required that the wallet server may never override the stored secrets, but will only write them if there is no secret for a customer ID.

1. A method for securing access to wallets in which crypto currencies and/or their secrets are stored, with a transaction server on which transaction logic runs to perform a transaction with a client device controlled by a user, comprising:
providing a wallet server on which wallets are managed,
assigning a user password and a unique ID to each user,
wherein, for the termination of a transaction, the access from the transaction server to the wallet server is based on the user password, an asymmetric server key pair, and a symmetric user key per user.

2. The method of claim 1 wherein the symmetric user key is encrypted with the user password and stored encrypted on the transaction server so that only the user has access to the user key.

3. The method of claim 1 wherein the private key of the asymmetric server key pair is stored on the wallet server and the public key of the asymmetric serving key pair is stored on the transaction server,
wherein, for the exchange of the symmetric user key, the symmetric user key has to be transmitted encrypted by the public key of the asymmetric serving key pair from the transaction server to the wallet server and is stored there in relation to the user.

4. The method of claim 1, wherein, in a transaction request for disbursing the crypto currency by the transaction server, the symmetric key is decrypted with the user password input, the transaction request is transmitted encrypted with the symmetric key to the wallet server and the out payment is made by the transaction server.

5. The method of claim 1 wherein the symmetric key having a unique user ID is stored on both the transaction server and the wallet server, and this user ID is also transmitted so that access is easier.

6. The method of claim 1, wherein, in the event of a change of the user password, the symmetrical key is decrypted with the old user password and encrypted with the new user password.

7. The method of claim 1, wherein the wallet server allows only the authorized and/or authenticated transaction server to establish a communication.

8. The method of claim 1, wherein the transaction server can only access read-only the wallet server, and a transaction is executed only when the amount of the crypto currency is high enough.

9. The method of claim 1, wherein a blockchain method is used to determine the state of the crypto currency.

10. The method of claim 1, wherein the symmetric key on the wallet server is never overwritten, but a symmetric key is written only when a key is not present for a user ID.

11. A system comprising a means for providing secure access to wallets in which crypto currencies and/or their keys are stored, with a transaction server and a wallet server, characterized by means and a configuration implementing the method according to claim 1.
